(19) United States
(12) Patent Application Publication
(10) Pub. No.: US 2022/0136653 A1
(43) Pub. Date: May 5, 2022

(54) INSULATING BLOCK INTENDED FOR THERMALLY INSULATING A STORAGE TANK

(71) Applicant: Gaztransport Et Technigaz, Saint Remy Les Chevreuse (FR)

(72) Inventors: Pierre Montfort, Saint Remy Les Chevreuse (FR); Benjamin Charpentier, Saint Remy Les Chevreuse (FR); Holger Frei, Saint Remy Les Chevreuse (FR)

(21) Appl. No.: 17/427,430

(22) PCT Filed: Feb. 11, 2020
(86) PCT No.: PCT/FR2020/050246

§ 371 Date: Jul. 30, 2021

(30) Foreign Application Priority Data
Feb. 14, 2019 (FR) 1901516

(51) Int. Cl. F17C 3/02; F17C 9/00; B67D 9/00

(52) U.S. Cl. CPC F17C 3/027; F17C 9/00; B67D 9/00; F17C 2203/0358; F17C 2203/0673; F17C 2203/0333; F17C 2260/012; F17C 2205/0355; F17C 2227/0135; F17C 2201/0157; F17C 2221/033; F17C 2223/0161; F17C 2260/011; F17C 2270/0107

(57) ABSTRACT

The invention relates to an insulating block intended for the thermal insulation of a fluid storage tank comprising:
a first plate (11) and a second plate that are parallel to one another, spaced apart in a thicknesswise direction of the insulating block;
supporting pillars inserted between said first and second plates (10, 11) in the thicknesswise direction of the insulating block; and
a heat-insulating lining positioned between the supporting pillars;
the first plate (11) comprising reinforced bearing zones (13) against which the supporting pillars (12) come to bear, the reinforced bearing zones (13) being linked to one another by a network of ribs (16).

### TECHNICAL FIELD

The invention relates to the field of tight and thermally insulating tanks, with membranes, for the storage and/or transportation of a fluid, such as a cryogenic fluid.

Tight and thermally insulating tanks with membranes are notably employed for the storage of liquefied natural gas (LNG), which is stored, at atmospheric pressure, at approximately −162° C. These tanks can be installed onshore or on a floating structure. In the case of a floating structure, the tank may be intended for the transportation of liquefied natural gas or to receive liquefied natural gas serving as fuel for the propulsion of the floating structure.

### TECHNOLOGICAL BACKGROUND

The document WO2016097578 discloses a tight and thermally insulating tank for the storage of liquefied natural gas comprising tank walls fixed to a supporting structure, such as the double-hull of a ship. Each tank wall comprises, in succession, in the thicknesswise direction, from the outside to the inside of the tank, a secondary thermally insulating barrier anchored to the supporting structure, a secondary sealing membrane resting against the secondary thermally insulating barrier, a primary thermally insulating barrier resting against the secondary sealing membrane and a primary sealing membrane which rests against the secondary thermally insulating barrier and is intended to be in contact with the liquefied natural gas stored in the tank.

The secondary and primary thermally insulating barriers comprise insulating blocks which are juxtaposed alongside one another. The insulating blocks comprise a bottom plate and a cover plate, parallel to one another, and supporting pillars which extend in the thicknesswise direction of the insulating block between the bottom plate and the cover plate. The insulating blocks further comprise an insulating lining which is positioned between the supporting elements.

In the embodiment illustrated in FIGS. 11 to 13 of the abovementioned document WO2016097578, the insulating blocks comprise load distribution structures. Given the fact that the supporting pillars are intended to take up a hydrostatic and hydrodynamic load to transmit it from the cover plate of the insulating block to the supporting structure, such load distribution structures make it possible to avoid the punching phenomena that are likely to exist in cases of excessive concentration of the compression stresses. The load distribution structures are inserted between the pillars and the cover plate, on the one hand, and between the pillars and the bottom plate, on the other hand.

The cover and bottom panels have a significant thickness so as to ensure flexural rigidity of the insulating blocks which is sufficient to limit the bending thereof, notably when they are subjected to thermal gradients. However, the counterpart of the mechanical rigidifying effect is the significant thickness of the cover and bottom plates which has the effect of degrading the thermal insulation performance of the insulating blocks and of increasing their weight.

The abovementioned insulating blocks are not therefore fully satisfactory.

### SUMMARY

One idea on which the invention is based is to propose an insulating block of the abovementioned type, intended for the thermal insulation of a fluid storage tank which offers an excellent trade-off between, on the one hand, a significant rigidity and, on the other hand, an effective thermal insulation.

For that, according to an embodiment, the invention provides an insulating block intended for the thermal insulation of a fluid storage tank comprising:
a first plate and a second plate that are parallel to one another, spaced apart in a thicknesswise direction of the insulating block;
supporting pillars inserted between said first and second plates in the thicknesswise direction of the insulating block; and
a heat-insulating lining positioned between the supporting pillars;
the first plate being molded in a composite material comprising a fiber-reinforced polymer matrix and comprising reinforced bearing zones against which the supporting pillars come to bear, the reinforced bearing zones being separated from one another by thinner zones and having a greater thickness than that of the thinner zones, the reinforced bearing zones being linked to one another by a network of ribs.

Thus, the ribs make it possible to reinforce the flexural rigidity of the first plate between the thicker bearing zones against which the pillars come to bear. This allows for a reduction of the thickness of the first plate between the bearing zones. Consequently, the weight of the insulating block is reduced, its thermal insulation performance is enhanced and all while obtaining a sufficient rigidity of the insulating block.

According to embodiments, such an insulating block can comprise one or more of the following features.

According to one embodiment, the insulating block comprises reinforced bearing zones aligned in rows parallel to a longitudinal direction and the network of ribs comprises ribs each extending between two of the adjacent reinforced bearing zones of one of the rows.

According to one embodiment, the insulating block comprises reinforced bearing zones aligned in columns parallel to a transverse direction and the network of ribs comprises ribs each extending between two of the adjacent reinforced bearing zones of one of the columns.

According to one embodiment, the network of ribs has two axes of symmetry at right angles to one another.

According to one embodiment, the transverse direction is orthogonal to the longitudinal direction.

According to one embodiment, the network of ribs comprises ribs each extending between two reinforced bearing zones aligned in a direction secant to longitudinal and transverse directions.

According to one embodiment, each rib has a form chosen from among a rectilinear form, a curvilinear form and an omega form.

According to one embodiment, the network of ribs comprises linking ribs which each link two ribs which each extend between two reinforced bearing zones.

According to one embodiment, the network of ribs comprises border ribs each extending along one of the edges of the first plate and the border ribs are each linked by ribs to one or more of the reinforced bearing zones.

According to one embodiment, the heat-insulating lining is an insulating polymer foam which adheres to the first plate and to the second plate. This makes it possible to increase the resistance of the insulating block to the shear forces that are exerted between the first plate and the second plate and to thus oppose the warping of the supporting pillars.

According to one embodiment, the insulating polymer foam adheres also to the supporting pillars. This contributes even more to increasing the resistance of the insulating block to the mechanical forces.

According to one embodiment, the heat-insulating lining is obtained by the molding of insulating polymer foam between the first plate and the second plate. The foam that is thus obtained is particularly advantageous in that it makes it possible to simply obtain an adaptation of the geometry of the heat-insulating lining to a complex geometry of the first plate, notably when the latter comprises a network of ribs.

According to another variant embodiment, the insulating polymer foam is prefabricated in the form of one or more precut blocks which have orifices to accommodate the supporting pillars and cutouts complementing the network of ribs.

According to one embodiment, the heat-insulating lining is a polyurethane foam, optionally fiber-reinforced. According to a particular embodiment, the fiber-reinforced polyurethane foam has a density of the order of 20 to 40 kg/m3. According to one embodiment, the reinforced polyurethane foam comprises a fiber ratio of between 3 and 5% by weight.

According to one embodiment, the fibers of the heat-insulating lining are chosen from among glass fibers, carbon fibers, aramid fibers and mixtures thereof.

According to one embodiment, at least one of the reinforced bearing zones has a fitting element which cooperates by joining of shapes with an end of one of the supporting pillars. According to one embodiment, the fitting element is a female element, such as a sleeve, into which the end of the supporting pillar is fitted. According to another embodiment, the fitting element is a male element which is inserted into a hollow end of the supporting pillars.

According to one embodiment, the first plate is produced by thermoforming of a thermoplastic matrix reinforced by a fiber reinforcement chosen from among mats, unidirectional (UD) or non-unidirectional plies and fabrics. The fiber reinforcement is for example made of glass fibers.

According to one embodiment, the thermoplastic matrix is for example chosen from among polyethylene, polypropylene, polyethyleneterephtalate, polyamide, polyoxymethylene, polyetherimide, polyacrylate and copolymers thereof.

According to one embodiment, the fibers are chosen from among glass fibers, carbon fibers, aramid fibers, linen fibers, basalt fibers and mixtures thereof.

According to one embodiment, the supporting pillars are produced in a composite material comprising a fiber-reinforced polymer matrix, the supporting pillars having a longitudinal direction oriented in the thicknesswise direction of the insulating block, more than 50% of the fibers of the supporting pillars being oriented parallel to the longitudinal direction of the supporting pillars or inclined by an angle of less than 45° with respect to said longitudinal direction. This is particularly advantageous for conferring on the supporting pillars a satisfactory compressive strength.

The supporting pillar fibers are chosen from among glass fibers, carbon fibers, aramid fibers, basalt fibers and the by-products and mixtures thereof.

According to one embodiment, the supporting pillars are produced by pultrusion, which is advantageous for obtaining a preferred orientation of the fibers in the direction of extrusion of the fibers and of the hollow forms.

According to one embodiment, the supporting pillars are hollow and lined with a heat-insulating lining.

According to one embodiment, the second plate is molded in a composite material comprising a fiber-reinforced polymer matrix and comprising reinforced bearing zones against which the supporting pillars come to bear, the reinforced bearing zones being separated from one another by thinner zones and having a greater thickness than that of the thinner zones, the reinforced bearing zones being linked to one another by a network of ribs.

The second plate can have one or more of the features presented hereinabove in relation to the first plate.

According to one embodiment, the first plate and the second plate are identical.

According to one embodiment, the first plate is a cover plate and the second plate is a bottom plate.

According to one embodiment, the invention also provides a tight and thermally insulating fluid storage tank comprising a thermal insulation barrier comprising a plurality of abovementioned insulating blocks juxtaposed, and a sealing membrane resting against the thermal insulation barrier. Such a tank can be produced with a single sealing membrane or with two sealing members alternated with two thermal insulation barriers.

Such a tank can form part of an onshore storage installation, for example for storing LNG, or be installed in a floating, coastal or deep water structure, notably a methane tanker ship, an LNG-fueled ship, a floating storage and regasification unit (FSRU), a floating production and storage offshore unit (FPSO) and the like.

According to one embodiment, a ship for transporting a fluid comprises a double-hull and an abovementioned tank positioned in the double-hull.

According to one embodiment, the invention also provides a method for loading or offloading such a ship, in which a fluid is conveyed through insulated pipelines from or to a floating or onshore storage installation to or from the tank of the ship.

According to one embodiment, the invention also provides a transfer system for a fluid, the system comprising the abovementioned ship, insulated pipelines arranged so as to link the tank installed in the hull of the ship to a floating or onshore storage installation and a pump for driving a fluid through the insulated pipelines from or to the floating or onshore storage installation to or from the tank of the ship.

### BRIEF DESCRIPTION OF THE FIGURES

The invention will be better understood and other aims, details, features and advantages thereof will become more clearly apparent from the following description of a number of particular embodiments of the invention, given in a purely illustrative and nonlimiting manner, with reference to the attached drawings.

FIG. 1 is a cutaway perspective view of a tank wall according to an embodiment.

FIG. 2 is a schematic view in cross section of an insulating block.

FIG. 3 illustrates an in situ molding method by injection of polymer foam between the cover plate and the bottom plate of an insulating block.

FIG. 4 is a front view of the cover plate of an insulating block which is turned toward the bottom plate.

FIG. 5 is a detailed view of the cover plate of FIG. 4.

FIG. 6 is a cutaway schematic representation of a methane tanker tank and of a terminal for loading/offloading from this tank.

FIG. 7 is a schematic representation of a cover plate illustrating a network of ribs according to a variant embodiment.

FIG. 8 is a schematic representation of a cover plate illustrating a network of ribs according to a variant embodiment.

FIG. 9 is a schematic representation of a cover plate illustrating a network of ribs according to a variant embodiment.

FIG. 10 is a schematic representation of a cover plate illustrating a network of ribs according to a variant embodiment.

FIG. 11 is a schematic representation of a cover plate illustrating a network of ribs according to a variant embodiment.

FIG. 12 is a schematic representation of a cover plate illustrating a network of ribs according to a variant embodiment.

FIG. 13 is a schematic representation of a cover plate illustrating a network of ribs according to a variant embodiment.

FIG. 14 is a schematic representation of a cover plate illustrating a network of ribs according to a variant embodiment.

FIG. 15 is a schematic representation of a cover plate illustrating a network of ribs according to a variant embodiment.

FIG. 16 is a schematic representation of a cover plate illustrating a network of ribs according to a variant embodiment.

FIG. 17 is a schematic representation of a cover plate illustrating a network of ribs according to a variant embodiment.

FIG. 18 is a schematic representation of a cover plate illustrating a network of ribs according to a variant embodiment.

FIG. 19 is a schematic representation of a cover plate illustrating a network of ribs according to a variant embodiment.

FIG. 20 is a schematic representation of a cover plate illustrating a network of ribs according to a variant embodiment.

### DESCRIPTION OF THE EMBODIMENTS

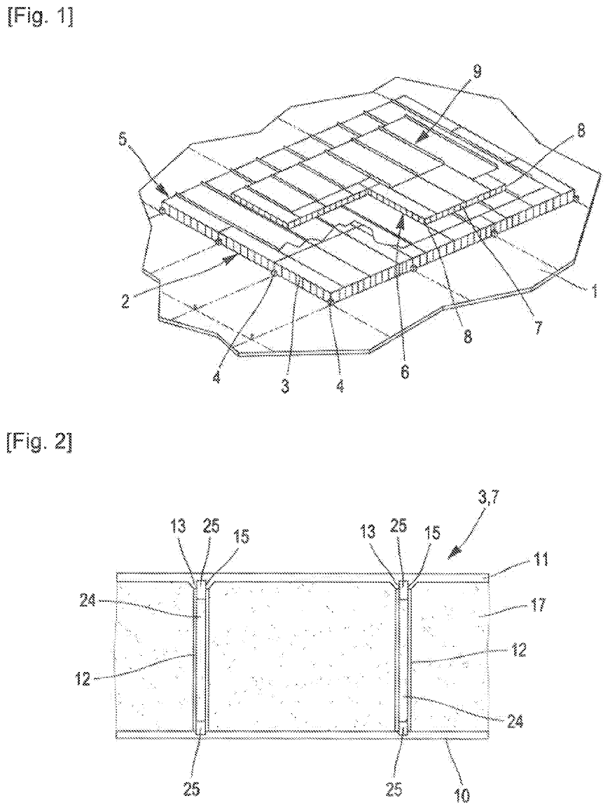

In FIG. 1, a wall of a tight and thermally insulating tank is represented. The general structure of such a tank is well known and has a polyhedral form. The following will therefore set out only to describe a tank wall zone, it being understood that all the walls of the tank can have a similar general structure. The wall of the tank comprises, from the outside to the inside of the tank, a supporting wall 1, a secondary thermally insulating barrier 2 which is formed by self-supporting insulating blocks 3, juxtaposed on the supporting structure 1 and anchored thereto by secondary retaining members 4, a secondary sealing membrane 5 supported by the insulating blocks 3, a primary thermally insulating barrier 6 formed by self-supporting insulating blocks 7, juxtaposed and anchored on the secondary sealing membrane 5 by primary retaining members 8 and a primary sealing membrane 9, supported by the insulating blocks 7 and intended to be in contact with the cryogenic fluid contained in the tank.

The supporting structure comprises a plurality of supporting walls 1 defining the general form of the tank. The supporting structure can notably be formed by the hull or the double-hull of a ship. The supporting wall 1 can notably be a self-supporting metal sheet or, more generally, any kind of rigid partition exhibiting appropriate mechanical properties.

The primary 9 and secondary 5 sealing membranes are, for example, composed of a continuous expanse of metal strakes with raised edges, said strakes being welded by their raised edges onto parallel welding supports secured to the insulating blocks 3, 7. The metal strakes are, for example, made of Invar®, that is to say an alloy of iron and nickel whose expansion coefficient typically lies between 1.2×10⁻⁶ and 2×10⁻⁶ K⁻¹, or iron alloy with high manganese content whose expansion coefficient is typically of the order of 7 to 9×10⁻⁶ K⁻¹. In the case of a tank of a ship, the strakes are preferably oriented parallel to the longitudinal direction 10 of the ship.

The secondary insulating blocks 3 and the primary insulating blocks 7 can have identical or different structures.

The secondary 3 and primary 7 insulating blocks have a rectangular parallelepipedal form defined by two large faces, or main faces, and four small faces, or lateral faces. According to one embodiment, the secondary 3 and primary 7 insulating blocks have the same length and the same width, the secondary insulating block 3 being, however, thicker than the primary insulating block 7.

FIG. 2 is a schematic view, in cross section, of the structure of an insulating block 3, 7 intended to form a secondary or primary insulating block. The insulating block 3, 7 comprises a bottom plate 10 and a cover plate 11 that are parallel, spaced apart in the thicknesswise direction of the insulating block 3, 7. The bottom plate 10 and the cover plate 11 define the main faces of the insulating block 3, 7.

The cover plate 11 has a supporting outer surface making it possible to receive the secondary 5 or primary 9 sealing membrane. The cover plate 11 also has grooves, not illustrated, for receiving welding supports that make it possible to weld the metal strakes of the secondary 5 or primary 9 sealing membrane to one another. The grooves have an L-shaped form and there are, for example, two of them per insulating block 3, 7. By convention, the longitudinal direction of the insulating block 3, 7 corresponds to the length of said insulating block 3, 7.

The insulating block 3, 7 comprises supporting pillars 12 extending in the thicknesswise direction of the insulating block 3, 7. The supporting pillars 11 bear, on the one hand, against the bottom plate 10 and, on the other hand, against the cover plate 11. The supporting pillars 12 make it possible to transmit the normal forces applied to the cover plate 11 to the bottom plate 10.

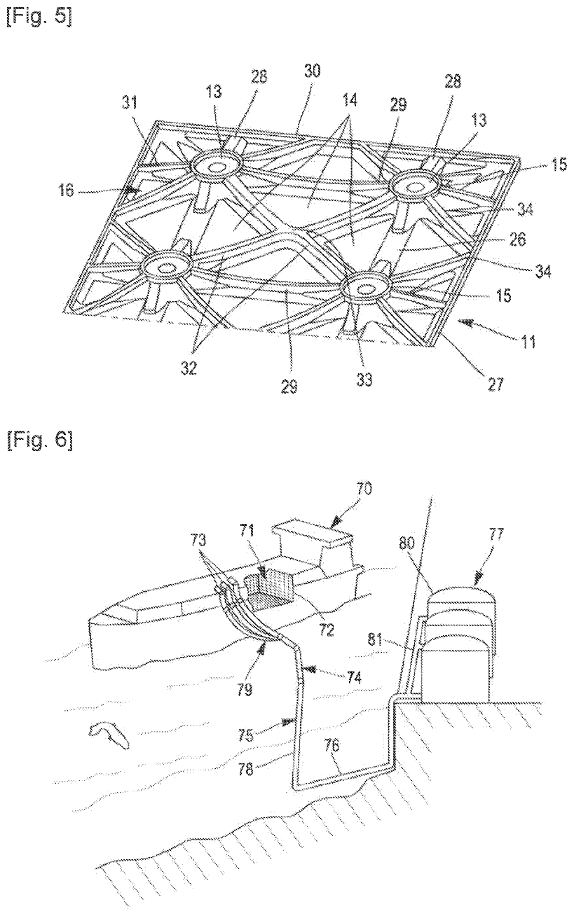

As represented, in FIGS. 4 and 5, the cover plate 11 comprises reinforced bearing zones 13 against which the supporting pillars 12 come to bear. The reinforced bearing zones 13 have a thickness greater than that of the other zones of the cover plate 11, which are hereinafter qualified by the term “thinner zones” 14. It will be noted that the term “thinner” here has a relative meaning and signifies that the thinner zones 14 have a lesser thickness than that of the reinforced bearing zones 13. The reinforced bearing zones 13 make it possible to avoid phenomena of excessive concentration of the stresses in the zone of contact with the supporting pillars 12. By way of example, the thickness of the reinforced bearing zones 13 of the cover plate 11 is between 15 and 35 mm, for example of the order of 25 mm, while the thickness of the thinner zones 14 is between 1 and 10 mm, for example of the order of 2 to 4 mm.

Moreover, according to one embodiment, the two ends of the supporting pillars 12 are respectively fitted into a fitting element 15 formed in the cover plate 11 and into a fitting element formed in the bottom plate 10. The fitting elements 15 can be of female type, such as sleeves for example, in which the ends of the supporting pillars 12 engage by joining of forms. Alternatively, the fitting elements 15 are of male type and are fitted into the hollow ends of the supporting pillars 12.

In the embodiment represented in FIGS. 4 and 5, the fitting elements 15 of the cover plate 11 are each formed by an annular rim formed in one of the reinforced bearing zones 13 of the cover plate 11. According to embodiments, the supporting pillars 12 are also fixed to the cover plate 11, for example by gluing. According to one embodiment, the fitting elements 15 of the cover plate 11 and those of the bottom plate 10 have different structures.

Moreover, the cover plate 11 comprises a network of ribs 16, notably represented in FIGS. 4 and 5, linking the reinforced bearing zones 13 to one another and intended to reinforce the flexural rigidity of the cover panel. The network of ribs 16 thus makes it possible to limit the thickness of the cover plate 11 outside of the reinforced bearing zones 13 against which the supporting pillars 12 bear, so as to reduce the weight of the insulating block 3, 7 and improve the thermal insulation performance of the insulating block 3, 7, while retaining a sufficient rigidity of the cover plate 11.

The insulating block 3, 7 also comprises a heat-insulating lining 17, notably illustrated in FIG. 2, which is positioned between the cover plate 11 and the bottom plate 10, in the spaces not occupied by the supporting pillars 12.

Advantageously, the heat-insulating lining 17 is an insulating polymer foam, such as low-density fiber-reinforced polyurethane foam. The insulating polymer foam is, for example, a polyurethane foam having a density of between 20 and 40 kg/m3, for example of the order of 35 kg/m3. The fiber ratio advantageously lies between 3 and 5% by weight. The fibers are, for example, glass fibers, but can also be carbon fibers, aramid fibers and mixtures thereof.

According to one embodiment, the insulating polymer foam is molded in-situ between the cover plate 11 and the bottom plate 10 in the spaces not occupied by the supporting pillars 12. Thus, the insulating polymer foam adheres to the bottom plate 10, to the cover plate 11 and to the supporting pillars 12. Consequently, the insulating polymer foam increases the resistance of the insulating block 3, 7 to the shear forces that are exerted between the bottom plate 10 and the cover plate 11 of the insulating block 3, 7 and thus opposes the warping of the supporting pillars 12. Furthermore, the injection molding of the insulating foam in-situ in an insulating block 3, 7 having a cover plate 11 of complex geometry, as described above, is particularly advantageous in that it makes it possible to simply obtain an adaptation of the geometry of the heat-insulating lining 17 to the complex geometry of the cover plate 11.

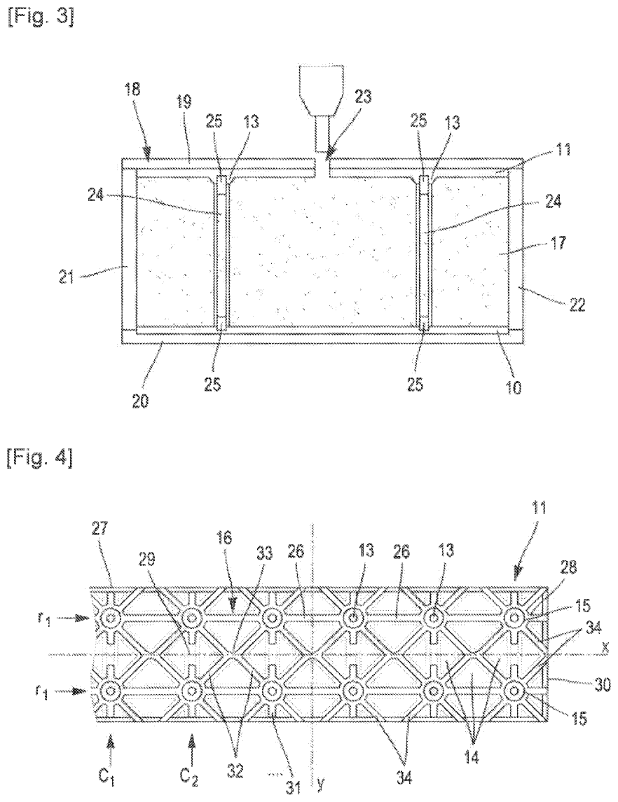

To do this, as represented in FIG. 3, a pre-assembled structure composed of the cover plate 11, the bottom plate 10 and the supporting pillars 12 is positioned in a mold 18. The mold 18 comprises a cover 19 and a bottom 20 that respectively come to bear against the cover plate 11 and the bottom plate 10 of the insulating block 3, 7, and four peripheral walls 21, 22, two of which are represented in FIG. 3, which extend between the cover 19 and the bottom 20 of the mold 18 along the edges of the bottom plate 10 and of the cover plate 11.

Moreover, the mold 18 has one or more injection orifices 23 that allow the insulating foam forming the heat-insulating lining 17 to flow between the cover plate 11 and the bottom plate 10. As represented in FIG. 3, when the injection orifice 23 is formed in the cover 19 of the mold 18, the cover plate 11 of the insulating block 3, 7 then comprises a corresponding orifice. According to another advantageous embodiment that is not represented, the injection orifice is formed in the bottom plate 10 of the insulating block 3, 7 which avoids a degradation of the flat surface of the cover plate 11 intended to support a membrane.

According to another embodiment that is not represented, the mold 18 does not comprise a cover and the pre-assembled structure which is positioned in the mold comprises only one of the bottom 10 or cover 11 plates with the associated supporting pillars 12. Said pre-assembled structure is positioned in the mold in such a way that said bottom 10 or cover 11 plate is positioned against the bottom 20 of the mold 18. The other of the bottom 10 or cover 11 plates is assembled against the supporting pillars 12 before the expansion of the foam reaches the bottom 10 or cover 11 plate.

According to another embodiment that is not represented, the insulating polymer foam is prefabricated in the form of one or more pre-cut blocks which have orifices to accommodate the supporting pillars 12 and cutouts complementing the network of ribs 16 formed in the cover plate 11. The block of insulating polymer foam is advantageously glued to the cover plate 11 and to the bottom plate 10 so as to increase the resistance of the insulating block 3, 7 to the mechanical forces, and notably to the shear forces exerted between the bottom plate 10 and the cover plate 11 of the insulating block 3, 7 so as to thus oppose the warping of the supporting pillars 12.

In order to produce a cover plate 11 that has reinforced bearing zones 13 and a network of ribs 16, said cover plate 11 is advantageously obtained by the molding of a composite material having a fiber-reinforced polymer matrix.

According to one embodiment, the cover plate 11 is produced by a method of thermoforming of a sheet of composite material, that is to say that the cover plate 11 is formed from a sheet of composite material by creep of said sheet of composite material under temperature, pressure and, optionally, vacuum conditions.

The cover plate 11 is, for example, produced in a composite material commonly referred to by the acronym GMT, for “Glass fiber Mat reinforced Thermoplastics”. A material of this type comprises a thermoplastic matrix reinforced by a fiber reinforcement chosen from among mats, unidirectional (UD) or non-unidirectional plies and fabrics. The fiber reinforcement is, for example, made of glass fibers. Such a material is intended to be pressed hot. Such materials have a good mechanical resistance and for example exhibit a thermal conductivity of the order of 400 mW/m·K at 20° C.

The thermoplastic matrix is, for example, chosen from among polyethylene, polypropylene, polyethyleneterephtalate, polyamide, polyoxymethylene, polyetherimide, polyacrylate and copolymers thereof.

The fibers are chosen from among glass fibers, carbon fibers, aramid fibers, linen fibers, basalt fibers and mixtures thereof.

According to another embodiment, the cover plate 11 is produced by a method of molding a composite material comprising fibers and a thermosetting matrix. The molding method is, for example, a compression molding of a composite material of mixture type to be molded into a sheet referred to by the acronym SMC, for “Sheet Molding Compound”, or of mixture type to be molded in bulk, referred to by the acronym BMC for “Bulk Molding Compound”.

The thermosetting matrix is, for example, chosen from among polyester, vinyl ester, epoxy and polyurethane.

Furthermore, the fibers associated with the thermosetting matrix are of the same nature as those mentioned above in relation to the thermoplastic matrix, that is to say chosen from among glass fibers, carbon fibers, aramid fibers, linen fibers, basalt fibers and mixtures thereof.

According to variant embodiments, the reinforced bearing zones 13 and the network of ribs 16 are obtained by overmolding of a composite material on a flat sheet of composite material.

According to one embodiment, the supporting pillars 12 are produced in a composite material comprising fibers and a thermoplastic or thermosetting matrix by a pultrusion method. The supporting pillars 12 therefore have a tubular form. The use of the pultrusion method is particularly advantageous in that it makes it possible to obtain a preferred orientation of the fibers in a direction parallel to the longitudinal direction of the supporting pillars 12. Also, advantageously, more than 50% of the fibers of the supporting pillars 12 are oriented parallel to the longitudinal direction of the supporting pillars 12 or inclined by an angle of less than 45° with respect to said longitudinal direction. This makes it possible to obtain a satisfactory compressive strength without increasing the heat-conducting section of said supporting pillars 12. The fibers of the supporting pillars 12 are, for example, chosen from among glass fibers, carbon fibers, aramid fibers, linen fibers, basalt fibers and mixtures thereof.

As represented in FIGS. 2 and 3, such supporting pillars 12 have a hollow form, the interior of said supporting pillars 12 is advantageously lined with a heat-insulating lining 24. The supporting pillars 12 are advantageously filled with heat-insulating lining before the supporting pillars 12 are joined to the cover plate 11 and to the bottom plate 10, which makes it possible to avoid the presence of piercings likely to weaken said supporting pillars 12. Moreover, according to one embodiment, the supporting pillars 12 are equipped with end-fittings 25 which close the two ends of the supporting pillars 12 and thus prevent the heat-insulating lining 24 positioned inside said supporting pillars 12 from being separated from said supporting pillars 12. The end-fittings 25 can notably be glued onto the ends of the supporting pillars 12 or inserted by force into the latter.

The heat-insulating lining 24 housed inside the supporting pillars 12 is, for example, an insulating polymer foam, such as polyurethane foam, which is molded in-situ inside the supporting pillars 12. The insulating polymer foam can notably be poured into the supporting pillars 12 during the pultrusion thereof, after the pultrusion thereof simultaneously or after the pouring of the insulating polymer foam between the cover 11 and bottom 10 plates.

According to another variant embodiment, the heat-insulating lining 24 consists of a pre-cut block of insulating polymer foam which is fitted into each supporting pillar 12.

The reinforced bearing zones 13 and the network of ribs 16 can have numerous different forms. Advantageously, the network of ribs 16 has two axes of symmetry, namely an axis of symmetry parallel to the longitudinal axis x of the cover plate 11 and an axis of symmetry parallel to the transverse axis y of the cover plate 11.

In the embodiment represented in FIGS. 4 and 5, the supporting pillars 12 and, consequently, the reinforced bearing zones 13, are aligned along a plurality of rows r1, r2, two in the embodiment represented, extending parallel to the longitudinal direction x of the insulating block 3, 7. Furthermore, in this embodiment, the reinforced bearing zones 13 are also aligned along a plurality of columns c1, c2, etc. extending parallel to the transverse direction y of the insulating block 3, 7. According to other embodiments, the supporting pillars 12 and the reinforced bearing zones 13 are distributed in staggered fashion. Furthermore, in an advantageous embodiment, the supporting pillars 12 and the reinforced bearing zones 13 are distributed equidistantly.

In the embodiment represented in FIGS. 4 and 5, the cover plate 11 comprises a plurality of rectilinear ribs 26 which extend parallel to the longitudinal direction x of the cover plate 11 and which link, pairwise, the adjacent reinforced bearing zones 13 of one and the same row r1, r2. The cover plate 11 also comprises rectilinear ribs 27 which extend along the longitudinal edges of the cover plate 11 and rectilinear ribs 28 which link the reinforced bearing zones 13 positioned at the end of each of the rows r1, r2 to the adjacent transverse edge of the cover plate 11.

The cover plate 11 also comprises rectilinear ribs 29 which extend transversely, that is to say at right angles to the longitudinal direction x of the cover plate 11, and which link two adjacent reinforced bearing zones 13 of one and the same column c1, c2, etc. The cover plate 11 also comprises rectilinear ribs 30 parallel to the transverse direction y, which extend along the transverse edges of the cover plate 11 and rectilinear ribs 31 which link the reinforced bearing zones 13, positioned at the end of each of the columns c1, c2, etc., to the adjacent longitudinal edge of the cover plate 11.

Moreover, the cover plate 11 comprises diagonal ribs 32 which link each reinforced bearing zone 13 to a reinforced bearing zone 13 belonging to an adjacent column c1, c2, etc., and to an adjacent row r1, r2. In the embodiment represented, the diagonal ribs 32 cross in a crossing zone 33 extending parallel to the longitudinal direction x of the cover plate 11. The cover plate 11 further comprises diagonal ribs 34 which extend parallel to the abovementioned diagonal ribs 32 and which each link either one of the reinforced bearing zones 13 positioned at the end of one of the rows r1, r2 to the adjacent transverse edge or one of the reinforced bearing zones 13 positioned at the end of one of the columns c1, c2, etc. to the adjacent longitudinal edge.

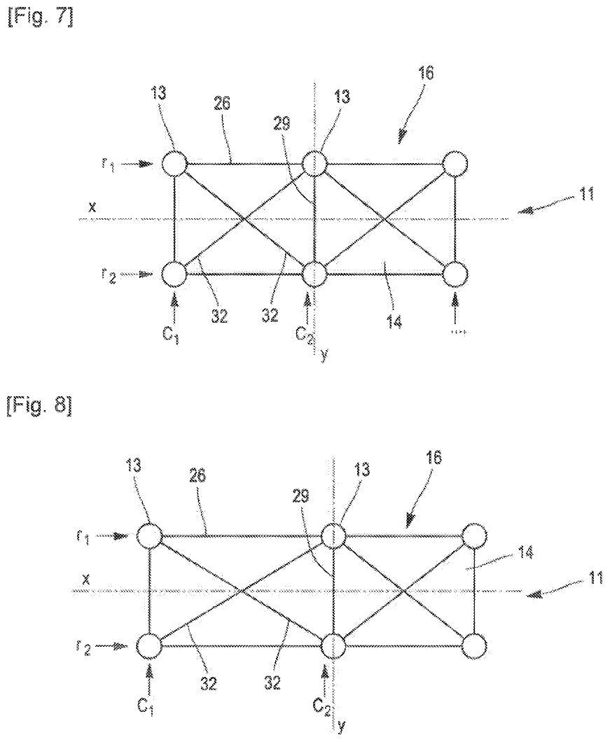

FIG. 7 schematically illustrates another arrangement of the ribs 26, 29, 32 and of the reinforced bearing zones 13. This embodiment differs from the embodiment described in relation to FIGS. 4 and 5 in that the diagonal ribs 32 are entirely rectilinear such that the crossing zone 33 between two secant diagonal ribs 32 has no portion extending parallel to the longitudinal direction x of the cover plate 11. Note also that, in the embodiment represented, the separation between two adjacent rows r1, r2 is equal to the distance between two adjacent columns c1, c2, etc. such that the diagonal ribs 32 are at right angles to one another.

FIG. 8 schematically illustrates another arrangement of the ribs 26, 29, 32 and of the reinforced bearing zones 13. This embodiment differs from that described above in relation to FIG. 7 in that the reinforced bearing zones 13 of one and the same row r1, r2 are not positioned equidistant from one another. Also, the diagonal ribs 32 are not necessarily at right angles to one another.

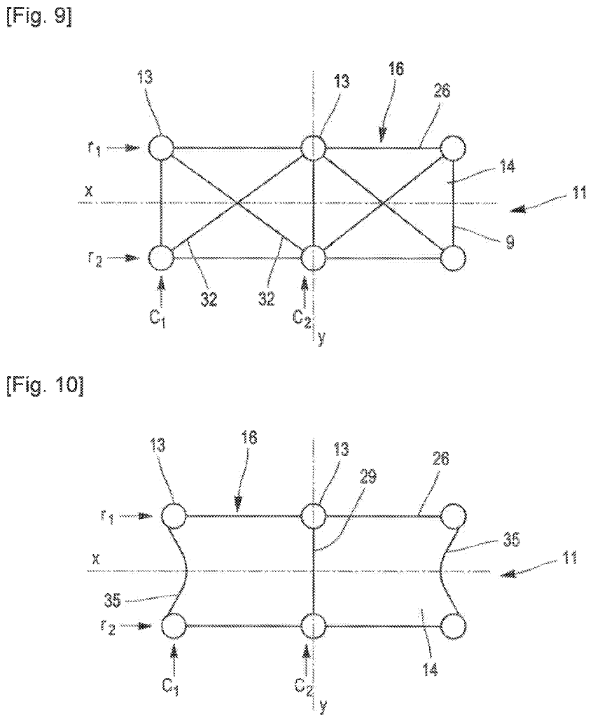

The embodiment represented in FIG. 9 differs from that described above in relation to FIG. 7 in that the reinforced bearing zones 13 belonging to a central column, referenced c2 in FIG. 9, are not linked by a rib.

The embodiment illustrated in FIG. 10 differs from that described above in relation to FIG. 7, notably in that the cover plate 11 has no diagonal ribs 32 linking each reinforced bearing zone 13 to an adjacent reinforced bearing zone 13 belonging to an adjacent row r1, r2 and to an adjacent column c1, c2, etc. Furthermore, in this embodiment, the adjacent reinforced bearing zones 13 of the columns c1, positioned at the ends of the cover plate 11, are linked to one another by curvilinear ribs 35.

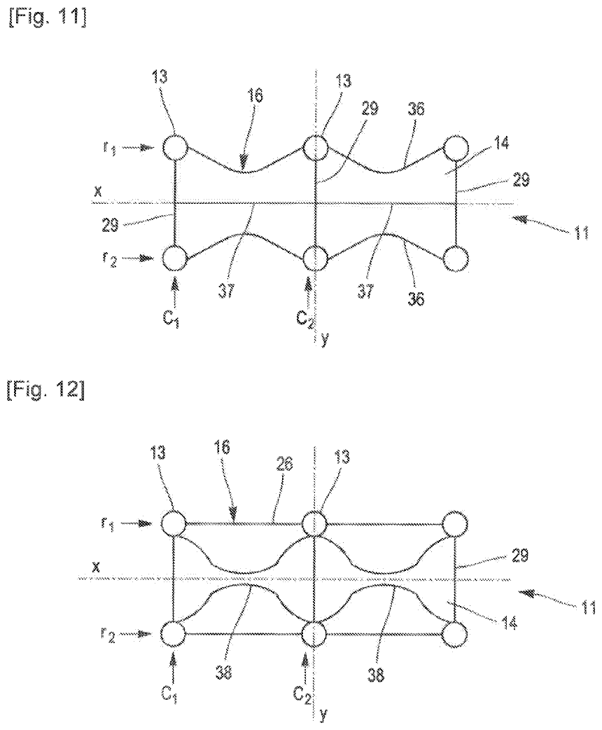

In the embodiment illustrated in FIG. 11, the ribs 36 which pairwise link the adjacent reinforced bearing zones 13 of one and the same row r1 are curvilinear. The cover plate 11 further comprises ribs 29, here rectilinear, which link, pairwise, the adjacent reinforced bearing zones 13 of one and the same column c1, c2. Furthermore, in this embodiment, the cover plate 11 is equipped with linking ribs 37 which extend in the longitudinal direction x of the cover plate 11 between two adjacent rows r1, r2 and which thus link the ribs 29.

In FIG. 12, the cover plate 11 comprises ribs 26 which, pairwise, link the adjacent reinforced bearing zones 13 of one and the same row r1, r2 and ribs 29 which, pairwise, link the adjacent reinforced bearing zones 13 of one and the same column c1, c2, etc. Furthermore, the adjacent reinforced bearing zones 13 of one and the same row r1, r2 are, here, linked pairwise by an omega-form rib 38. The omega-form ribs 38 linking the adjacent reinforced bearing zones 13 of one and the same row r1, r2 may or may not be linked to the omega-form ribs 38 of the reinforced bearing zones 13 of the adjacent row r1, r2.

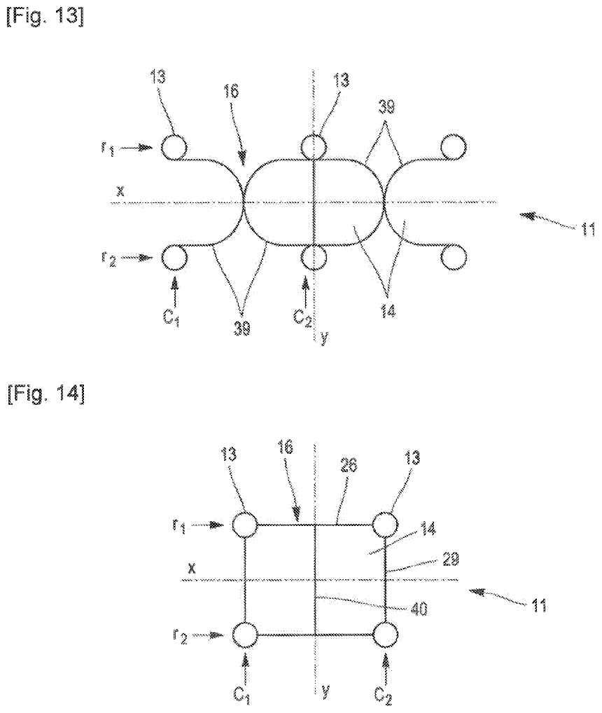

In FIG. 13, the cover plate 11 comprises curvilinear ribs 39 which each link two reinforced bearing zones 13 of one and the same column c1, c2 and are each connected to the curvilinear rib 39 linking the two reinforced bearing zones 13 of an adjacent column c1, c2, etc. Furthermore, the cover plate 11 also comprises an optional rib 29 which links the two reinforced bearing zones 13 of a central column, referenced c2 in FIG. 13.

FIG. 14 represents a cover plate 11 according to a variant embodiment. In this figure, the cover plate 11 comprises only four reinforced bearing zones 13. However, according to other variants that can be envisaged, the cover plate 11 comprises a greater number of reinforced bearing zones 13, the pattern presented in FIG. 14 being repeated several times. In this embodiment, the cover plate 11 comprises rectilinear ribs 26 which link the adjacent reinforced bearing zones 13 of each row r1, r2. The cover plate 11 further comprises rectilinear ribs 29 which link the adjacent reinforced bearing zones 13 of each column c1, c2, etc. Finally, the cover plate 11 here comprises a linking rib 40 which extends transversely between two ribs 26 of longitudinal orientation.

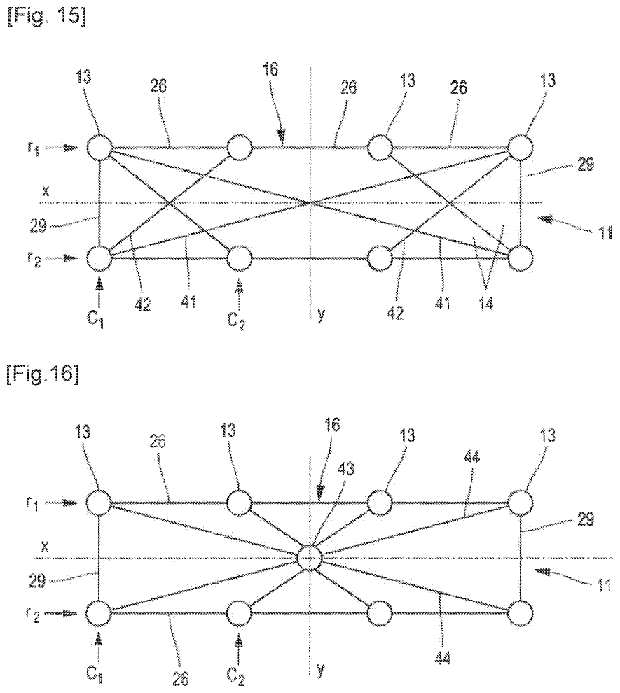

In FIG. 15, the cover plate 11 comprises ribs 26 which link the adjacent reinforced bearing zones 13 of each row r1 and transverse ribs which link the adjacent reinforced bearing zones 13 of the columns positioned at the ends of the cover plate 11. Moreover, the cover plate 11 further comprises diagonal ribs 41, here rectilinear, which each link the reinforced bearing zone 13 of a first row r1, r2, positioned in proximity to a first end of the cover plate 11, to the reinforced bearing zone 13 of a second row positioned in proximity to an opposite second end of the cover plate 11. Furthermore, in FIG. 15, the cover plate 11 comprises other, optional diagonal ribs 42 which each link the reinforced bearing zone 13 of a row r1, r2 which is positioned in proximity to one of the ends of the cover plate 11 to a reinforced bearing zone of an adjacent row r1, r2 and of an adjacent column c1, c2, etc.

In relation to FIGS. 16 to 20, other variant embodiments are described hereinbelow in which the arrangement of the supporting pillars 12, and consequently of the reinforced bearing zones 13, is different from the arrangements mentioned above, notably in that said reinforced bearing zones 13 are not all arranged in the form of columns and rows.

In the embodiment illustrated in FIG. 16, the reinforced bearing zones 13 are aligned along two rows r1, r2 extending parallel to the longitudinal direction x of the insulating block 3, 7. Furthermore, the reinforced bearing zones 13 are also aligned along a plurality of columns c1, c2, etc., here four of them, extending parallel to the transverse direction y of the insulating block 3, 7. Moreover, the cover plate 11 comprises a central reinforced bearing zone 43 which is positioned at the center of the cover plate 11. The cover plate 11 comprises ribs 26, here rectilinear, which extend parallel to the longitudinal direction x of the cover plate 11 and which link, pairwise, the reinforced bearing zones 13 of one and the same row c1, c2. The cover plate 11 further comprises two ribs 29 which extend parallel to the transverse direction y and which, pairwise, link the reinforced bearing zones 13 of the two columns positioned at the ends of the cover plate 11. Finally, the cover plate 11 comprises radial ribs 44 which link the central reinforced bearing zone 43 to each of the other reinforced bearing zones 13.

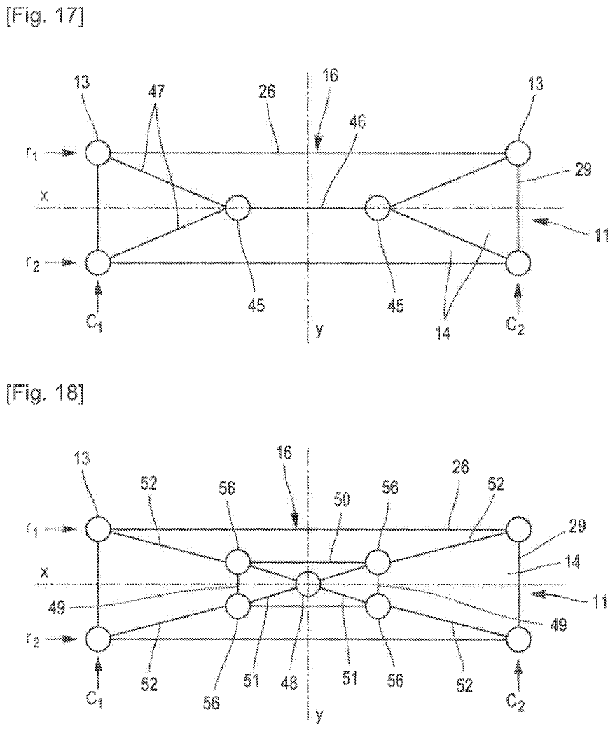

In the embodiment illustrated in FIG. 17, the cover plate 11 comprises four outer reinforced bearing zones 13 which are aligned pairwise in the longitudinal direction and in the transverse direction y of the cover plate 11. The cover plate 11 also comprises two central reinforced bearing zones 45 which are aligned and evenly distributed along a central axis parallel to the longitudinal direction x of the cover plate 11. The cover plate 11 comprises ribs 26, of longitudinal orientation, and ribs 29, of transverse orientation, which, pairwise, link the four outer reinforced bearing zones 13. Furthermore, the two central reinforced bearing zones 45 are linked to one another by a rib 46, here rectilinear, of longitudinal orientation. Finally, each of the two central reinforced bearing zones 45 are linked to the two adjacent outer reinforced bearing zones 13 by ribs 47.

In the embodiment illustrated in FIG. 18, the cover plate 11 comprises four outer reinforced bearing zones 13, as described in relation to FIG. 17. Moreover, the cover plate 11 comprises five central reinforced bearing zones 48, 56, four of which are aligned pairwise parallel to the longitudinal direction x and parallel to the transverse direction y so as to define a rectangle and the fifth 48 is positioned at the intersection of the diagonals of the four other central reinforced bearing zones 13. The cover plate 11 comprises ribs 29 parallel to the transverse direction y and ribs 26 parallel to the longitudinal direction x which, pairwise, link the four outer reinforced bearing zones 13. Furthermore, the cover plate 11 comprises ribs 49 parallel to the transverse direction y and ribs 50 parallel to the longitudinal direction x which, pairwise, link the four central reinforced bearing zones 13 defining the rectangle. Each of the four central reinforced bearing zones 13 defining the rectangle is, furthermore, linked by a diagonal rib 51 to the fifth central reinforced bearing zone 48. Finally, each of the four outer reinforced bearing zones 13 is, furthermore, linked to the neighboring central reinforced bearing zone 56 by a rib 52.

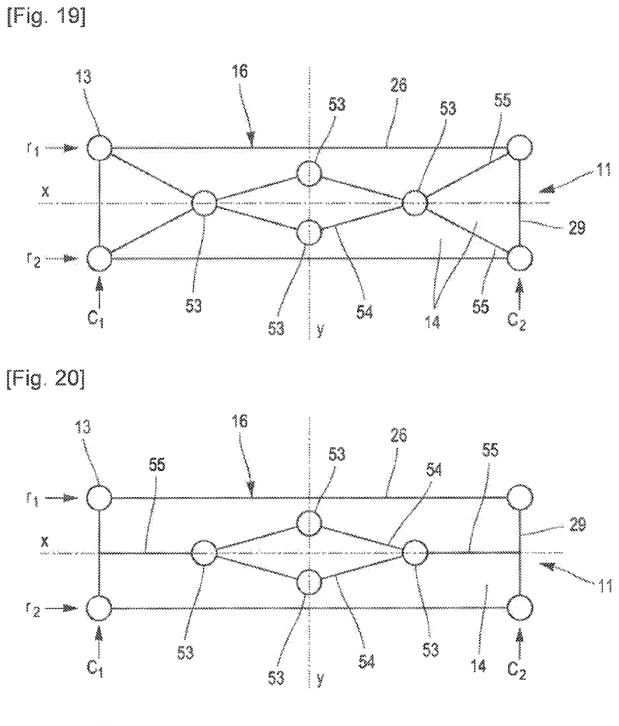

In the embodiment illustrated in FIG. 19, the cover plate 11 comprises four outer reinforced bearing zones 13, as described in relation to FIG. 17. The cover plate 11 comprises ribs 26, 29 which, pairwise, link the four outer reinforced bearing zones 13. Furthermore, the cover plate 11 comprises four central reinforced bearing zones 53 defining a rhomb whose diagonals are respectively oriented parallel to the longitudinal direction x and parallel to the transverse direction y. Furthermore, the cover plate 11 comprises ribs 54 which link the four central reinforced bearing zones 13 by each running along one of the sides of the rhomb defined by said four central reinforced bearing zones 53. Finally, each of the four outer reinforced bearing zones 13 is linked to the adjacent central reinforced bearing zone 53 by a rib 55.

The embodiment illustrated in FIG. 20 differs from the embodiment described above in relation to FIG. 19 in that the four outer reinforced bearing zones 13 are not linked to one of the central reinforced bearing zones 53. However, the two central reinforced bearing zones 53 closest to the two longitudinal ends of the cover plate 11 are each linked to the adjacent rib 29 by a linking rib.

Although the invention has been described in relation to a number of particular embodiments, it is quite clear that it is in no way limited thereto and that it encompasses all the technical equivalents of the means described and the combinations thereof provided they fall within the scope of the invention.

In particular, the different geometries of the ribs and arrangements of the reinforced bearing zones as described above can be combined with one another.

Note also that, while the arrangements and geometries of the ribs and of the reinforced bearing zones are described above in relation to the cover plate 11, similar arrangements and geometries can also be used for the bottom plate 10.

With reference to FIG. 6, a cutaway view of a methane tanker ship 70 shows a tight and insulated tank 71 of generally prismatic form mounted in the double-hull 72 of the ship. The wall of the tank 71 comprises a primary tight barrier intended to be in contact with the LNG contained in the tank, a secondary tight barrier arranged between the primary tight barrier and the double-hull 72 of the ship, and two insulating barriers arranged respectively between the primary tight barrier and the secondary tight barrier and between the secondary tight barrier and the double-hull 72.

As is known per se, loading/offloading pipelines 73 on the top deck of the ship can be connected, by means of appropriate connectors, to a maritime or port terminal to transfer an LNG cargo from or to the tank 71.

FIG. 6 represents an example of a maritime terminal comprising a loading and offloading station 75, a submarine line 76 and an onshore installation 77. The loading and offloading station 75 is a fixed offshore installation comprising a movable arm 74 and a riser 78 which supports the movable arm 74. The movable arm 74 bears a bundle of insulated flexible pipes 79 that can be connected to the loading/offloading pipelines 73. The steerable movable arm 74 adapts to all methane tanker templates. A link line not represented extends inside the riser 78. The loading and offloading station 75 allows the methane tanker 70 to be loaded and offloaded from or to the onshore installation 77. The latter comprises liquefied gas storage tanks 80 and link lines 81 linked by the submarine line 76 to the loading or offloading station 75. The submarine line 76 allows liquefied gas to be transferred between the loading or offloading station 75 and the onshore installation 77 over a great distance, for example 5 km, which allows the methane tanker ship 70 to be kept at a great distance from the coast during the loading and offloading operations.

To generate the pressure necessary for the transfer of the liquefied gas, use is made of pumps embedded in the ship 70 and/or pumps with which the onshore installation 77 is equipped and/or pumps with which the loading and offloading station 75 is equipped.

The use of the verb “include” or “comprise” and its conjugate forms does not exclude the presence of elements or steps other than those stated in a claim.

In the claims, any reference symbol between parentheses should not be interpreted as a limitation of the claim.

1. An insulating block intended for the thermal insulation of a fluid storage tank comprising:
a first plate and a second plate that are parallel to one another, spaced apart in a thicknesswise direction of the insulating block;
supporting pillars inserted between said first and second plates in the thicknesswise direction of the insulating block; and
a heat-insulating lining positioned between the supporting pillars;
the first plate being molded in a composite material comprising a fiber-reinforced polymer matrix and comprising reinforced bearing zones against which the supporting pillars come to bear, the reinforced bearing zones being separated from one another by thinner zones and having a greater thickness than that of the thinner zones, the reinforced bearing zones being linked to one another by a network of ribs.

2. The insulating block as claimed in claim 1, comprising reinforced bearing zones aligned in rows parallel to a longitudinal direction and wherein the network of ribs comprises ribs each extending between two of the adjacent reinforced bearing zones of one of the rows.

3. The insulating block as claimed in claim 1, comprising reinforced bearing zones aligned in columns parallel to a transverse direction and wherein the network of ribs comprises ribs each extending between two of the adjacent reinforced bearing zones of one of the columns.

4. The insulating block as claimed in claim 1, wherein the network of ribs comprises ribs each extending between two reinforced bearing zones aligned in a direction secant to the longitudinal and transverse directions.

5. The insulating block as claimed in claim 2, wherein each rib has a form chosen from a rectilinear form, a curvilinear form and an omega form.

6. The insulating block as claimed in claim 2, wherein the network of ribs comprises linking ribs which each link two ribs which each extend between two reinforced bearing zones.

7. The insulating block as claimed in claim 1, wherein the network of ribs comprises border ribs each extending along one of the edges of the first plate and wherein the border ribs are each linked by a rib to one or more of the reinforced bearing zones.

8. The insulating block as claimed in claim 1, wherein the heat-insulating lining is an insulating polymer foam which adheres to the first and second plates.

9. The insulating block as claimed in claim 7, wherein the insulating polymer foam also adheres to the supporting pillars.

10. The insulating block as claimed in claim 8, wherein the heat-insulating lining is obtained by molding insulating polymer foam between the first and second plates.

11. The insulating block as claimed in claim 1, wherein the heat-insulating lining is a fiber-reinforced polyurethane foam having a density of between 20 and 40 kg/m3 and a fiber ratio of between 3 and 5% by weight.

12. The insulating block as claimed in claim 1, wherein at least one of the reinforced bearing zones has a fitting element which cooperates by joining of shapes with one end of one of the supporting pillars

13. The insulating block as claimed in claim 1, wherein the supporting pillars are produced in a composite material comprising a fiber-reinforced polymer matrix, the supporting pillars having a longitudinal direction oriented in the thicknesswise direction of the insulating block, more than 50% of the fibers of the supporting pillars being oriented parallel to the longitudinal direction of the supporting pillars or inclined by an angle of less than 45° with respect to said longitudinal direction of the supporting pillars.

14. The insulating block as claimed in claim 1, wherein the first plate is produced by thermoforming of a thermoplastic matrix reinforced by a fiber reinforcement chosen from among mats, plies and fabrics.

15. The insulating block as claimed in claim 1, the second plate is molded in a composite material comprising a fiber-reinforced polymer matrix and comprising reinforced bearing zones against which the supporting pillars come to bear, the reinforce d bearing zones being separated from one another by thinner zones and having a greater thickness than that of the thinner zones, the reinforced bearing zones being linked to one another by a network of ribs.

16. The insulating block as claimed in claim 1, wherein the supporting pillars are produced by pultrusion.

17. The insulating block as claimed in claim 1, wherein the supporting pillars are hollow and lined with a heat-insulating lining.

18. The insulating block as claimed in claim 1, wherein the first plate is a cover plate.

19. A tight and thermally insulating fluid storage tank comprising a thermal insulation barrier comprising a plurality of insulating blocks as claimed in claim 1, and a sealing membrane resting against the thermal insulation barrier.

20. A ship for transporting a fluid, the ship comprising a double-hull and a tank as claimed in claim 19 positioned in the double-hull.

21. A fluid transfer system, the system comprising a ship as claimed in claim 20, insulated pipelines arranged so as to link the tank installed in the hull of the ship to a floating or onshore storage installation and a pump for driving a fluid through the insulated pipelines from or to the floating or onshore storage installation to or from the tank of the ship.

22. A method for loading or offloading a ship as claimed in claim 20, wherein a fluid is conveyed through insulated pipelines from or to a floating or onshore storage installation to or from the tank of the ship.
